(19) United States
(12) Patent Application Publication
(10) Pub. No.: US 2013/0000589 A1
(43) Pub. Date: Jan. 3, 2013

(54) MULTICYLINDER IN-LINE INTERNAL COMBUSTION ENGINE FOR A MOTOR VEHICLE AND METHOD FOR OPERATING THE ENGINE

(75) Inventor: Michael Roehrig, Koeln (DE)

(73) Assignee: Ford Global Technologies, LLC, Dearborn, MI (US)

(21) Appl. No.: 13/533,820

(22) Filed: Jun. 26, 2012

(30) Foreign Application Priority Data
Jun. 29, 2011 (DE) 102011078356.3

(51) Int. Cl. F02B 75/06

(52) U.S. Cl. 123/192.2

(57) ABSTRACT

An internal combustion engine in a vehicle is described herein. The internal combustion engine may include two outer pistons, each of the pistons arranged in a separate cylinder and positioned in an in-line configuration in which a straight line extends through each of the axes of the pistons, a crankshaft including a plurality of crank throws, each crank throw coupled to a separate piston, and a flywheel coupled to a first end of the crankshaft. The engine may further include a belt pulley coupled to a second end of the crankshaft and a balancing arrangement including a first balancing mass coupled to a belt pulley and a second balancing mass coupled to a flywheel, the relative separation between the first balancing mass and the second balancing mass measured on a plane perpendicular to a rotational axis of the crankshaft is less than 170°.

### CROSS REFERENCE TO RELATED APPLICATION

The present application claims priority to German Patent Application Number 102011078356.3, filed on Jun. 29, 2011, the entire contents of which are hereby incorporated by reference for all purposes.

### BACKGROUND/SUMMARY

In an internal combustion engine having multiple cylinders (e.g., 3 cylinders) in an in-line configuration, balancing arrangements, such as counterweights, are used to reduce or in some cases substantially prevent the occurrence of vibrations (e.g., first order vibrations), which may be exerted on the crankshaft in the form of inertial forces by the first and the third cylinders, for example. In this case, the torque due to the “yaw excitation” is aligned parallel to the cylinder's axes, and the torque due to the “pitch excitation” is aligned perpendicularly to the cylinder's axes and to axis of the crankshaft. In such a case, the ratio between the yaw excitation and the pitch excitation may be adjusted via the respective size of the balancing masses (e.g., counterweights) integrated in or coupled to the crankshaft.

German patent application, DE 102 45 376 A1, discloses a crankshaft for an in-line three-cylinder reciprocating piston engine on which two balancing masses are provided in the drivetrain to reduce the bearing loads on the crankshaft bearings. The balancing masses in the crankshaft form an angle of 180° relative to one another in a plane perpendicular to the rotational axis of the crankshaft, and produce equal and opposite balancing forces. In the drivetrain the balancing plane formed by the balancing forces forms an angle of 30° with the first crank throw. Further attempts have been made to dampen vibrations in the engine caused by rotation of the crankshaft. However, the dampening may involve tradeoffs between longitudinal vibrations and vertical vibrations in the drivetrain.

The Inventors have recognized several drawbacks with the above mentioned crankshaft configurations. Firstly, the crankshaft disclosed in the German patent application, DE 102 45 376, may experience excitation (e.g., vibration) in a direction perpendicular to both the rotational axis of the crankshaft as well as a gravitational axis. This direction may be referred to as a yaw axis. The yaw vibration may be referred to as “yawing moment-induced” pitch excitation due to the non-diagonal terms in the inertia matrix of the drivetrain. As a result noise, vibration, and harshness (NVH) may be increased in the vehicle, thereby decreasing customer satisfaction.

As such in one approach, an internal combustion engine in a vehicle is provided. The internal combustion engine may include two outer pistons, each of the pistons arranged in a separate cylinder and positioned in an in-line configuration in which a straight line extends through each of the axes of the pistons, a crankshaft including a plurality of crank throws, each crank throw coupled to a separate piston, and a flywheel coupled to a first end of the crankshaft. The engine may further include a belt pulley coupled to a second end of the crankshaft and a balancing arrangement including a first balancing mass coupled to a belt pulley and a second balancing mass coupled to a flywheel, the relative separation between the first balancing mass and the second balancing mass measured on a plane perpendicular to a rotational axis of the crankshaft is less than 170°.

When the balancing masses are positioned in this way vibrations during engine operation are reduced. Specifically, vibrations in a direction perpendicular to a vertical axis and the rotational axis of the crankshaft are reduced. Furthermore yaw vibrations are also reduced. Consequently NVH is reduced in the engine, thereby improving customer satisfaction.

In some embodiments the first balancing mass is positioned at 190° with respect to a first outer crank throw included in the plurality of crank throws and the second balancing mass is positioned at 200° with respect to the first outer crank throw. It will be appreciated that the pitch and yaw vibrations may be further reduced when the balancing masses are positioned in this way.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIGS. 1A-B show a schematic illustration of a crankshaft provided with a counterweight arrangement for a combustion engine having three cylinders;

FIGS. 2A-2B and 3A-3B show diagrams intended to illustrate the operation of the invention; and

FIG. 4 shows a method for operating an internal combustion engine in a motor vehicle.

The invention is explained in greater detail below with reference to the figures.

### DETAILED DESCRIPTION

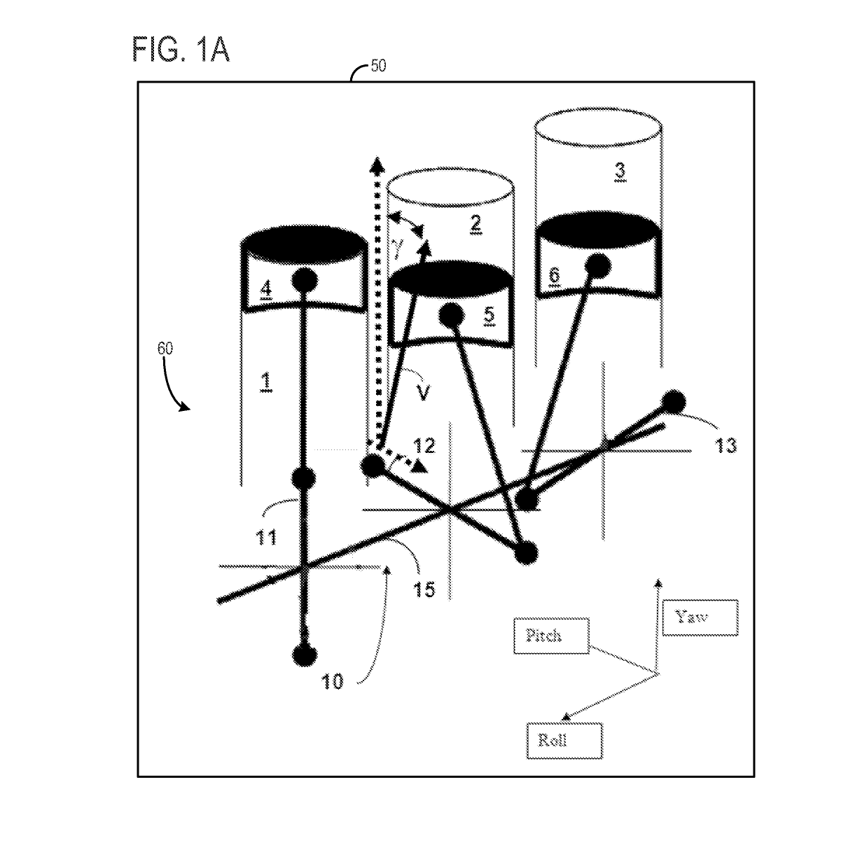

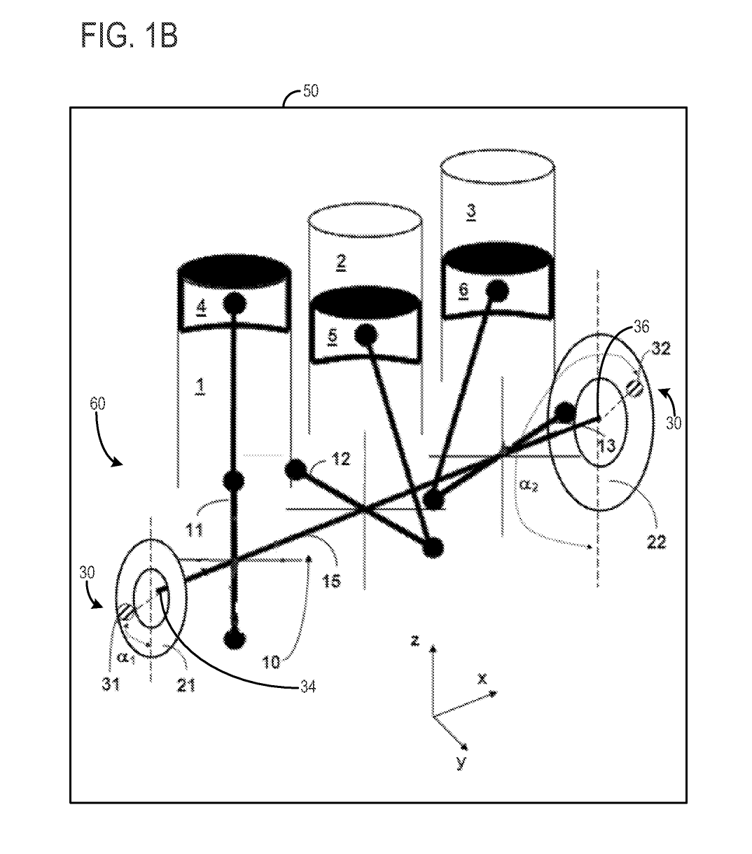

FIG. 1A shows an internal combustion engine 50. The internal combustion engine 50 includes three cylinders (1, 2, and 3) and corresponding pistons (4, 5, and 6). The pistons are configured to move in a reciprocating motion within the cylinders. Thus, each of the pistons are at least partially enclosed by walls of a corresponding cylinder. It will be appreciated that an air/fuel mixture may be delivered to the cylinders and combustion cycles may be performed in the cylinders, thereby moving the pistons in a reciprocating motion. Engine operation may be defined as a period of time when the engine is performing cyclical combustion in the cylinders. The engine 50 further includes a crankshaft 10 coupled to each of the pistons (4, 5, and 6). The crankshaft 10 rotates about a crankshaft axis 15 extending in an x-direction in the coordinate system, shown in FIG. 1B. The crankshaft 10 includes three crank throws (11, 12, and 13), depicted as lines in FIG. 1A. The three crank throws are consecutively arranged along the crankshaft axis 15. In some examples, the crank throws (11, 12, and 13) may be distributed at angular intervals of 120° around the crankshaft axis 15. The crankshaft 10 and therefore crank throws (11, 12, and 13) is included in a drivetrain 60. The crank throws 11 and 13 are outer crank throws and the crank throw 12 is an inner crank throw positioned between the outer crank throws.

FIG. 1B shows a balancing arrangement 30 having two balancing masses 31, 32. This balancing arrangement 30 may be configured to at least partially balance the inertia forces caused by the rotating masses at the crankshaft 10.

Specifically, the first balancing mass 31 is coupled to a belt pulley 21, shown in FIG. 1B, and the second balancing mass 32 is coupled to a flywheel 22, shown in FIG. 1B. The belt pulley 21 is coupled to a first end 34 of the crankshaft 10 and included in the drivetrain 60. On the other hand, the flywheel 22 is coupled to a second end 36 of the crankshaft 10 and included in the drivetrain 60. However, it will be appreciated that additional balancing masses, such as counterweights, may be arranged on the crankshaft 10 (e.g., crank throws 11 and 13), in addition to the balancing masses 31, 32, in some embodiments. Further in other embodiments, the balancing masses 31 and 32 may be coupled to the crankshaft 10.

Continuing with FIG. 1B, reference sign “21” denotes a belt pulley and “22” denotes a flywheel in the internal combustion engine 50. Furthermore, the balancing mass 31 is arranged on the belt pulley 21 and the balancing mass 32 is arranged on the flywheel 22. The distance between the balancing masses (31 and 32) along the crankshaft axis 15 extending in the axial direction is greater than the exterior distance between the two outer crank throws (11 and 13). Thus, the balancing masses (31 and 32) extend beyond the outer crank throws (11 and 13) in an axial direction. The torque directions for the yawing, pitching, and rolling motion are indicated in FIG. 1A. These directions may be referred to as a yaw axis, pitch axis, and rolling axis. The rolling axis may be the axis of the crankshaft. The yaw axis may be a vertical axis and the pitch axis is perpendicular to both the yaw axis and the rolling axis.

For the (resultant) torque vector \vec{M} as the product of the inertia tensor Θ and the angular acceleration \ddot{φ}

\vec{M}=Θ·{umlaut over (\vec{φ} (1)

the following equation applies:

$$\begin{matrix}\vec{M} = ( \begin{matrix}{M}_{pitch} \\ {M}_{Roll} \\ {M}_{Yaw}\end{matrix} ) \\ = ( \begin{matrix}{M}_{Pitch} \\ 0 \\ {M}_{Yaw}\end{matrix} ) \\ = {\vec{M}}_{osc . mass} + {\vec{M}}_{crankshaft} + {\vec{M}}_{flywheel \& beltpulley}\end{matrix} \qquad ( 2 )$$

where the angular acceleration \ddot{φ} is given by:

$$\ddot{ϕ} = ( \begin{matrix}{\ddot{ϕ}}_{Pitch} \\ {\ddot{ϕ}}_{Roll} \\ {\ddot{ϕ}}_{Yaw}\end{matrix} ) \qquad ( 3 )$$

and where the inertia tensor Θ is given by:

$$Θ = [ \begin{matrix}{Θ}_{11} & {Θ}_{12} & {Θ}_{13} \\ {Θ}_{21} & {Θ}_{22} & {Θ}_{23} \\ {Θ}_{31} & {Θ}_{32} & {Θ}_{33}\end{matrix} ] \qquad ( 4 )$$

The arrangement and, in particular, the angle at which the balancing masses (e.g., weights) are mounted relative to the remaining component in the drivetrain including the crankshaft, the flywheel and the belt pulley are configured in such a way that, taking account of the inertia tensor, a reduced and in some cases minimized rotation of the center of gravity of the arrangement in accordance with the pitch excitation arises during the operation of the internal combustion engine, i.e.

$$\ddot{ϕ} = ( \begin{matrix}0 \\ {\ddot{ϕ}}_{Roll} \\ {\ddot{ϕ}}_{Yaw}\end{matrix} ) \qquad ( 5 )$$

In practice, as will be explained in greater detail below, this may be achieved by modifying the angle between the balancing masses provided in the arrangement according to the invention and the crank throws in a suitable way.

From the above equations, the following is obtained:

$$\begin{matrix}{\ddot{ϕ}}_{Yaw} = - \frac{{Θ}_{22}}{{Θ}_{23}} {\ddot{ϕ}}_{Roll} \\ and & ( 6 ) \\ \frac{{M}_{Pitch}}{{M}_{Yaw}} = \frac{- {Θ}_{13} \frac{{Θ}_{22}}{{Θ}_{23}} + {Θ}_{12}}{- {Θ}_{33} \frac{{Θ}_{22}}{{Θ}_{23}} + {Θ}_{32}} = tan ( γ ) & ( 7 ) \\ {\vec{M}}_{flywheeel \& beltpulley} = {M}_{Yaw} ( \begin{matrix}tan ( γ ) \\ 0 \\ 1\end{matrix} ) - {\vec{M}}_{osc . mass} - {\vec{M}}_{crankshaft} & ( 8 )\end{matrix}$$

The residual pitch excitations of the drivetrain 60 may be reduced by selecting at least one of the angles α₁ and α₂ at which the balancing masses 31, 32 are positioned relative to the first crank throw 11 based on the equations 1-8, described above. Each of the angles α₁ and α₂ may be referred to as azimuthal angles. The angles α₁ and α₂ are a measure of the offset or relative angular separation between the balancing masses (31 and 32) and the first crank throw 11. Furthermore, it will be appreciated that the positions of the balancing masses from which angles α₁ and α₂ are measured may be at the center of mass of each balancing mass. Moreover, the end point from which the angles α₁ and α₂ are measured is on the rotational axis 15 of the crankshaft 10. Additionally, the angles α₁ and α₂ are measured in a plane perpendicular to the crankshaft axis 15, in the depicted embodiment. However in other embodiments the angles α₁ and α₂ may be measured in other planes. As shown, the angles α₁ and α₂ are measured in a clockwise direction about the crankshaft axis 15 from a downward axis. However, in other embodiments the angles α₁ and α₂ may be measured in a counterclockwise direction.

The angles α₁ and α₂ may be selected based on a function of the inverse of the inertia tensor of the arrangement of the balancing masses. The inertia tensor may be calculated using equations 1-8, shown above. In this arrangement, the first azimuthal angle α₁ and the second azimuthal angle α₂ may be selected in such a way that a reduced yaw excitation of the drivetrain 10 is achieved. In some examples, the yaw excitation may be minimized However, lesser degrees of yaw excitation reduction have been contemplated. Moreover, first azimuthal angle α₁ and the second azimuthal angle α₂ may also be selected to reduce and in some cases minimize the pitch excitation in the drivetrain. As a result, vibrations in the engine are reduced, thereby increasing customer satisfaction. A reduction in vibration may also increase the longevity of the engine 50.

Specifically in some embodiments, the angle α₁ is not equal to 30° and the angle α₂ is not 210°. The angle α₁ may differ from 30° by at least 5°, 10°, or in some cases 15° and the angle α₂ may also differ from 210° by at least 5°, 10°, or in some cases 15°. Further in some embodiments, the angle α₁ may be equal to 190° and the angle α₂ may be equal to 200°. It will be appreciated that when the balancing masses (31 and 32) are arranged in this way the vibrations in the drivetrain 60 may be reduced, thereby increasing customer satisfaction and increasing the longevity of the engine 50. This balancing mass arrangement may not only reduce vibrations in the pitch direction but the yaw direction as well.

The relative angular separation between the first and second balancing masses (31 and 32) is less than 170°, in some embodiments. In other embodiments the relative angular separation between the first and second balancing masses (31 and 32) is less than 90°. In the depicted embodiment, the relative angular separation between the balancing masses (31 and 32) is 10°. The angular separation between the first and second balancing masses may be measured in a plane perpendicular to the crankshaft axis 15. Moreover, the end point from which the angular separation between the balancing masses (31 and 32) is measured in on the crankshaft axis.

Furthermore, the balancing masses (31 and 32) may be arranged such that the direction of the resultant force of the drivetrain slopes at the resultant angle (γ) that is not equal to zero, the resultant angle (γ) is measured from a vertical axis, in the embodiment depicted in FIG. 1B. Therefore, the resultant angle (γ) is selected to reduce a pitch excitation of the drivetrain during operation of the engine, the direction of the pitch is perpendicular to the vertical axis and the crankshaft axis.

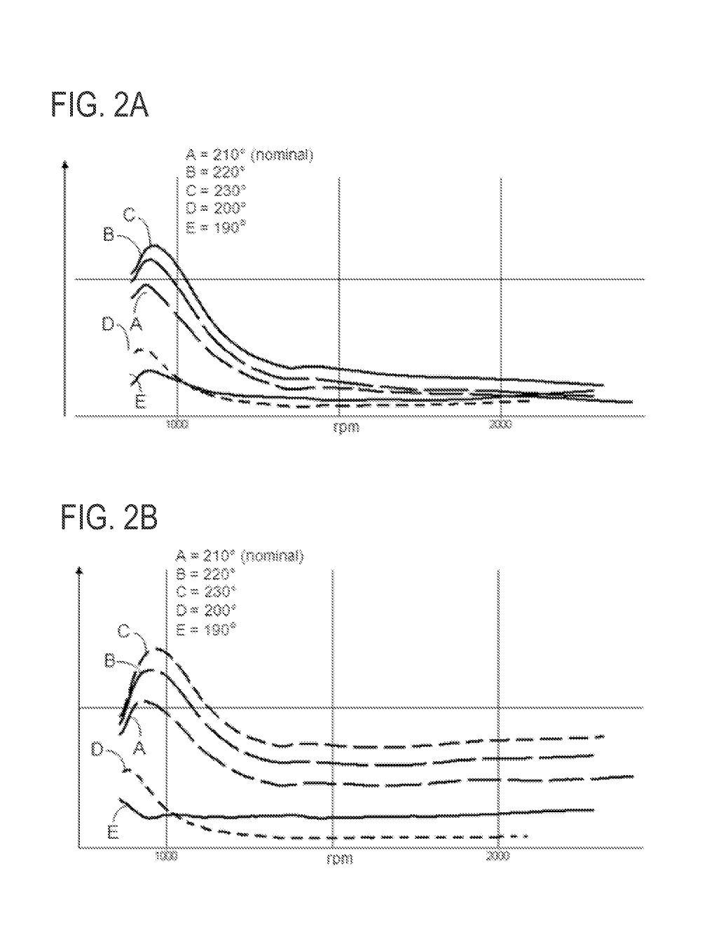

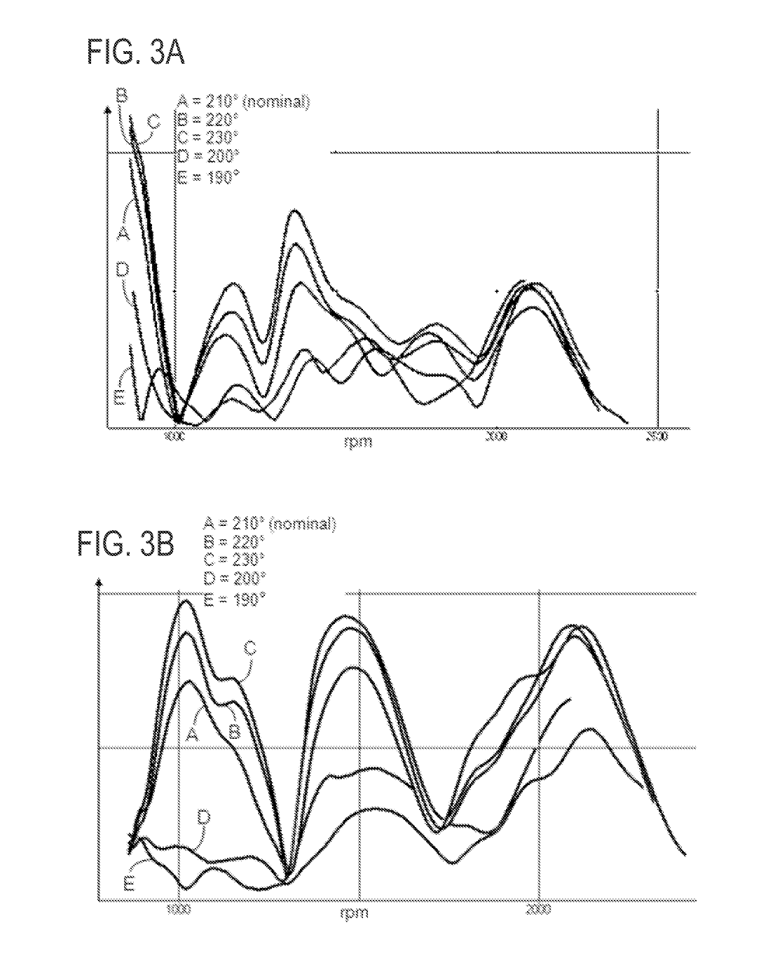

As can be seen from FIGS. 2A and 2B for the left hand and the right hand mounting point respectively, a significant reduction in the excitations of the drivetrain 60 in the vertical direction can be achieved when the balancing masses (31 and 32) are positioned in the way described above with regard to FIGS. 1A-1B when compared to drivetrains which may have balancing masses positioned 180° apart. In FIGS. 2A-2B, the value of the second azimuthal angle α₂ of balancing mass 32 on the flywheel 22 is indicated in curves “A”-“E”. According to FIGS. 2A and 2B, a significant reduction is achieved where α₂=190° and α₂=200°. In FIGS. 3A and 3B, the reduction in the vibrations which occur at the seat rail is illustrated, this likewise being most pronounced where α₂=190° and α₂=200°.

FIGS. 1A-1B provide for an internal combustion engine in a vehicle comprising two outer pistons, each of the pistons arranged in a separate cylinder and positioned in an in-line configuration in which a straight line extends through each of the axes of the pistons, a crankshaft including a plurality of crank throws, each crank throw coupled to a separate piston, a flywheel coupled to a first end of the crankshaft, a belt pulley coupled to a second end of the crankshaft, and a balancing arrangement including a first balancing mass coupled to a belt pulley and a second balancing mass coupled to a flywheel, the relative separation between the first balancing mass and the second balancing mass measured on a plane perpendicular to a rotational axis of the crankshaft is less than 170°.

FIGS. 1A-1B further provide for an internal combustion engine where the relative separation between the first and second balancing masses is less than 90°. FIGS. 1A-1B further provide for an internal combustion engine where the relative separation between the first and second balancing masses is 10°. FIGS. 1A-1B further provide for an internal combustion engine where the first balancing mass is offset from a first outer crank throw included in the plurality of crank throws by 190° and the second balancing mass is offset from the first outer crank throw by 210°. FIGS. 1A-1B further provide for an internal combustion engine where the first and second balancing masses each axially extend beyond two outer crank throws included in the plurality of crank throws. FIGS. 1A-1B further provide for an internal combustion engine where the crank throws are distributed at angles of 120 degrees with respect to each other. FIGS. 1A-1B further provide for an internal combustion engine where the first balancing mass is directly coupled to the belt pulley and the second balancing mass is directly coupled to the flywheel.

FIGS. 1A-1B further provide for an internal combustion engine further comprising an inner piston positioned between the outer pistons. FIGS. 1A-1B further provide for an internal combustion engine comprising a plurality of cylinders in an in-line configuration and a drivetrain comprising a crankshaft, which rotates about a crankshaft axis during the operation of the internal combustion engine and has a plurality of crank throws consecutively arranged in an axial direction along the crankshaft axis, each crank throw coupled to a separate piston arranged in one of the plurality cylinders, and a balancing arrangement configured to at least partially balance the inertia forces caused by revolving masses in the crankshaft, the balancing arrangement having at least two balancing masses, the balancing masses arranged such that the direction of the resultant force of the drivetrain slopes at a resultant angle (γ) that is not equal to zero, the resultant angle measured from a vertical axis.

FIGS. 1A-1B further provide for an internal combustion engine where the balancing masses include a first balancing mass and a second balancing mass, the first balancing mass is offset from a first crank throw by a first azimuthal angle α₁ and the second balancing mass is offset from the first crank throw by a second azimuthal angle α₂, the first and second azimuthal angles selected to reduce pitch excitation of the drivetrain during operation of the internal combustion engine, the direction of the pitch is perpendicular to the vertical axis and the crankshaft axis. FIGS. 1A-1B further provide for an internal combustion engine where the first azimuthal angle α₁ does not equal 30° and the second azimuthal angle α₂ does not equal 210°. FIGS. 1A-1B further provide for an internal combustion engine where the first azimuthal angle α₁ differs from 30° by at least 5° and the second azimuthal angle α₂ differs from 210° by at least 5°.

FIGS. 1A-1B further provide for an internal combustion engine where the first azimuthal angle α₁ differs from 30° by at least 10° and the second azimuthal angle α₂ differs from 210° by at least 10°. FIGS. 1A-1B further provide for an internal combustion engine where the first azimuthal angle α₁ differs from 30° by at least 15° and the second azimuthal angle α₂ differs from 210° by at least 15°. FIGS. 1A-1B further provide for an internal combustion engine where the first azimuthal angle α₁ and the second azimuthal angle α₂ are selected to reduce yaw excitation of the drivetrain, the direction of the yaw is parallel to the vertical axis.

FIGS. 1A-1B further provide for an internal combustion engine where the resultant angle (γ) is selected to reduce a pitch excitation of the drivetrain during operation of the engine, the direction of the pitch is perpendicular to the vertical axis and the crankshaft axis. FIGS. 1A-1B further provide for an internal combustion engine where the plurality of cylinders comprises three cylinders. FIGS. 1A-1B further provide for an internal combustion engine where one of the balancing masses is arranged on a flywheel and one of the balancing masses is arranged on a belt pulley, the flywheel and the belt pulley included in the drivetrain.

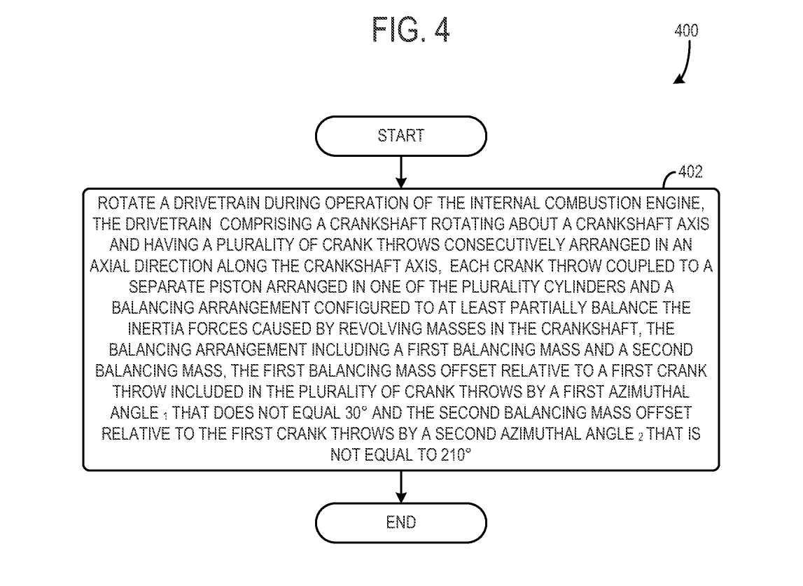

FIG. 4 shows a method 400 for operating an internal combustion engine in a motor vehicle. The method 400 may be implemented by the engine and drivetrain described above with regard to FIGS. 1A-1B or may be implemented by other suitable engines and drivetrains.

At 402 the method includes rotating a drivetrain during operation of the internal combustion engine, the drivetrain comprising a crankshaft rotating about a crankshaft axis and having a plurality of crank throws consecutively arranged in an axial direction along the crankshaft axis, each crank throw coupled to a separate piston arranged in one of the plurality cylinders and a balancing arrangement configured to at least partially balance the inertia forces caused by revolving masses in the crankshaft, the balancing arrangement including a first balancing mass and a second balancing mass, the first balancing mass offset relative to a first crank throw included in the plurality of crank throws by a first azimuthal angle α₁ that does not equal 30° and the second balancing mass offset relative to the first crank throws by a second azimuthal angle α₂ that is not equal to 210°.

In some examples, the first azimuthal angle measures the angle between the first crank throw and the first balancing mass in a plane perpendicular to the rotational axis of the crankshaft. Further in some examples the first azimuthal angle α₁ and the second azimuthal angle α₂ are selected as a function of the inverse of the intertia tensor of the drivetrain to reduce the pitch excitation of the drivetrain during operation of the internal combustion engine.

This concludes the description. The reading of it by those skilled in the art would bring to mind many alterations and modifications without departing from the spirit and the scope of the description. For example, engines operating in natural gas, gasoline, diesel, or alternative fuel configurations could use the present description to advantage.

1. An internal combustion engine in a vehicle comprising:
two outer pistons, each of the pistons arranged in a separate cylinder and positioned in an in-line configuration in which a straight line extends through each of the axes of the pistons;
a crankshaft including a plurality of crank throws, each crank throw coupled to a separate piston;
a flywheel coupled to a first end of the crankshaft;
a belt pulley coupled to a second end of the crankshaft; and
a balancing arrangement including a first balancing mass coupled to a belt pulley and a second balancing mass coupled to a flywheel, the relative separation between the first balancing mass and the second balancing mass measured on a plane perpendicular to a rotational axis of the crankshaft is less than 170°.

2. The internal combustion engine of claim 1, where the relative separation between the first and second balancing masses is less than 90°.

3. The internal combustion engine of claim 2, where the relative separation between the first and second balancing masses is 10°.

4. The internal combustion engine of claim 1, where the first balancing mass is offset from a first outer crank throw included in the plurality of crank throws by 190° and the second balancing mass is offset from the first outer crank throw by 210°.

5. The internal combustion engine of claim 1, where the first and second balancing masses each axially extend beyond two outer crank throws included in the plurality of crank throws.

6. The internal combustion engine of claim 1, where the crank throws are distributed at angles of 120 degrees with respect to each other.

7. The internal combustion engine of claim 1, where the first balancing mass is directly coupled to the belt pulley and the second balancing mass is directly coupled to the flywheel.

8. The internal combustion engine of claim 1, further comprising an inner piston positioned between the outer pistons.

9. An internal combustion engine in a motor vehicle comprising:
a plurality of cylinders in an in-line configuration; and
a drivetrain comprising:
a crankshaft, which rotates about a crankshaft axis during the operation of the internal combustion engine and has a plurality of crank throws consecutively arranged in an axial direction along the crankshaft axis, each crank throw coupled to a separate piston arranged in one of the plurality cylinders; and
a balancing arrangement configured to at least partially balance the inertia forces caused by revolving masses in the crankshaft, the balancing arrangement having at least two balancing masses, the balancing masses arranged such that the direction of the resultant force of the drivetrain slopes at a resultant angle (γ) that is not equal to zero, the resultant angle measured from a vertical axis.

10. The internal combustion engine of claim 9, where the balancing masses include a first balancing mass and a second balancing mass, the first balancing mass is offset from a first crank throw by a first azimuthal angle α₁ and the second balancing mass is offset from the first crank throw by a second azimuthal angle α₂, the first and second azimuthal angles selected to reduce pitch excitation of the drivetrain during operation of the internal combustion engine, the direction of the pitch is perpendicular to the vertical axis and the crankshaft axis.

11. The internal combustion engine of claim 10, where the first azimuthal angle α₁ does not equal 30° and the second azimuthal angle α₂ does not equal 210°.

12. The internal combustion engine of claim 10, where the first azimuthal angle α₁ differs from 30° by at least 5° and the second azimuthal angle α₂ differs from 210° by at least 5°.

13. The internal combustion of claim 10, where the first azimuthal angle α₁ differs from 30° by at least 10° and the second azimuthal angle α₂ differs from 210° by at least 10°.

14. The internal combustion of claim 10, where the first azimuthal angle α₁ differs from 30° by at least 15° and the second azimuthal angle α₂ differs from 210° by at least 15°.

15. The internal combustion engine of claim 9, where the plurality of cylinders comprises three cylinders.

16. The internal combustion engine of claim 9, where one of the balancing masses is arranged on a flywheel and one of the balancing masses is arranged on a belt pulley, the flywheel and the belt pulley included in the drivetrain.

17. A method for operating an internal combustion engine in a motor vehicle, the method comprising:
rotating a drivetrain during operation of the internal combustion engine, the drivetrain comprising a crankshaft rotating about a crankshaft axis and having a plurality of crank throws consecutively arranged in an axial direction along the crankshaft axis, each crank throw coupled to a separate piston arranged in one of the plurality cylinders and a balancing arrangement configured to at least partially balance the inertia forces caused by revolving masses in the crankshaft, the balancing arrangement including a first balancing mass and a second balancing mass, the first balancing mass offset relative to a first crank throw included in the plurality of crank throws by a first azimuthal angle α₁ that does not equal 30° and the second balancing mass offset relative to the first crank throws by a second azimuthal angle α₂ that is not equal to 210°.

18. The method of claim 17, where the first azimuthal angle measures the angle between the first crank throw and the first balancing mass in a plane perpendicular to the rotational axis of the crankshaft.
